(19) United States
(12) Patent Application Publication
(10) Pub. No.: US 2008/0243349 A1
(43) Pub. Date: Oct. 2, 2008

(54) Method and Apparatus for Speed Control

(75) Inventor: Hans L. TRAUTENBERG, Ottobrunn (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Muenchen (DE)

(21) Appl. No.: 12/055,720

(22) Filed: Mar. 26, 2008

(30) Foreign Application Priority Data
Mar. 27, 2007 (DE) 102007015303.3-32

(51) Int. Cl. B60W 30/14; G01C 21/00

(52) U.S. Cl. 701/93

(57) ABSTRACT

A device for automatically controlling the speed of a vehicle comprises a positioning sensor, which is designed to emit a position signal with the current position of the vehicle, a navigation database, in which the positions of the city limits are stored, and a speed control unit, to which the position signal is fed. The speed control unit is configured such that it determines, as a function of the position signal, the distance of the vehicle from the nearest city limits or a region with a speed limit in the direction of travel of the vehicle, based on data of the navigation database. It then generates, as a function of the determined distance, a speed setting signal, which reduces the current speed of the vehicle in such a manner that a predefined speed of the vehicle is reached no later than at the nearest city limits or the region with a speed limit.

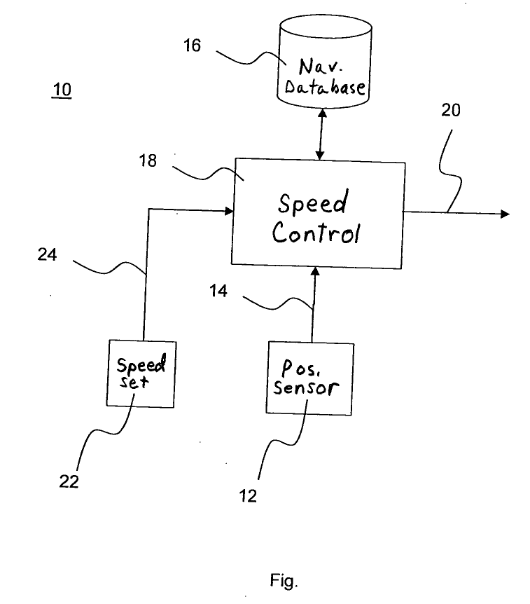

### BACKGROUND AND SUMMARY OF THE INVENTION

This application claims the priority of German patent document 10 2007 015 303.3-32, filed Mar. 27, 2007, the disclosure of which is expressly incorporated by reference herein.

The invention relates to a device for automatically controlling the speed of a vehicle.

The speed of a vehicle, such as a passenger car may be set by means of an automatic control unit-also called a “cruise control”-to a desired vehicle speed, which is then automatically maintained. A further refinement of the standard “cruise control” is the so-called “adaptive cruise control,” which, on automatically setting the speed, also observes the speed of the vehicles that are traveling ahead and then also sets the speed of one's own vehicle to match. Detailed information on “adaptive cruise control” may be found in the manual “Sicherheits—und Komfortsystems—Funktion, Regelung und Komponenten” [Safety, Comfort and Convenience Systems—Function, Control and Components], Bosch Kraftfahrzeugtechnik [Bosch Automotive Engineering], 3rd edition, October 2004.

Against this background, one object of the present invention is to provide an improved device and an improved method for automatic speed control.

This and other objects and advantages are achieved by the speed control method and apparatus according to the invention, in which a speed control unit is combined with a positioning sensor and a navigation database (or a plurality of navigation databases), and the data of the positioning sensor and the navigation database(s) are taken into account in controlling the speed of a vehicle. Thus, it is possible to control the vehicle speed in a way that is far better adapted to the special local features than in the case of a conventional speed control. In particular, the invention makes it possible to control the speed so that it is optimized in terms of time and energy, since, for example, on driving into localities or other regions the speed may be reduced by the control unit to the allowable speed. In particular, owing to the navigation data, the speed may be reduced by the control unit so early before driving into a locality or a region with a speed limit that the vehicle may coast at the allowable speed without having to brake in essence.

One embodiment of the invention provides a device that is intended for automatically controlling the speed of a vehicle and which comprises a positioning sensor, which is designed to emit a position signal with the current position of the vehicle, a navigation database, in which the positions of the city limits are stored, and a speed control unit, to which the position signal is fed and which is configured to determine, as a function of the position signal, the distance of the vehicle from the nearest city limits or a region with a speed limit in the direction of travel of the vehicle, by means of the data of the navigation database. As a function of the determined distance, the speed control unit generates a speed setting signal, which reduces the current speed of the vehicle in such a manner that a predefined speed of the vehicle is reached no later than at the nearest city limits or the region with a speed limit.

This device is especially suitable for integrating into the aforementioned “cruise control” or also an “adaptive cruise control.”

The predefined speed is typically lower than the current vehicle speed—for example, a maximum speed that is generally allowable in localities. Thus, the vehicle may be driven, above all, energy efficiently, because situations are avoided in which the vehicle drives as far as just up to the city limits at the allowable speed for highways (usually much higher), and then has to significantly decelerate to the allowable speed in the locality. It may also contribute to safer driving, because a driver is actively assisted in maintaining the maximum allowable speed. This embodiment of the invention can be implemented relatively economically, above all, with the use of a commercially available navigation database.

According to one embodiment of the invention, the allowable speeds in localities may be stored in the navigation database. Furthermore, the speed control unit may be designed in such a manner as to use an allowable speed in the corresponding locality as the predefined speed in order to determine the nearest city limits in the direction of travel. This feature is especially advantageous in regions where localities often have a wide range of allowable speeds—for example, in some places 50 km/h, but in others only 30 km/h.

Furthermore, the altitude profiles of roads may be stored, according to one embodiment of the invention, in the navigation database. Or a digital terrain model may be filed in a second navigation database. This second navigation database and the first navigation database are used together to determine the altitude profile of the road. Furthermore, the speed control unit may be configured in such a manner as to consider the altitude profile of the road, on which the vehicle is currently driving, in the generation of the speed setting signal. This feature permits the speed to be controlled with even higher precision.

Furthermore, the speed control unit may be configured in such a manner, according to one embodiment of the invention, as to determine, as a function of the determined distance, an optimal location, at which the decrease in the current speed of the vehicle is started. For example, it may be determined that a decrease in speed will not begin until after a predefined minimum distance before the city limits or the region with a speed limit.

Furthermore, the speed control unit may be configured in such a manner, according to one embodiment of the invention, as to determine the optimal location with regard to optimizing the time required to reach the city limits or the region with a speed limit. In this case, for example, it can be automatically calculated that after the optimal location without providing in essence any more gas and, thus, without any more fuel consumption, the vehicle will arrive at the city limits or the region with a speed limit solely by coasting at the predefined speed.

Furthermore, the speed control unit may be configured in such a manner, according to one embodiment of the invention, as to determine the optimal location with regard to optimizing the energy required to reach the city limits or the region with a speed limit. In this case, for example, the optimal location may be chosen in such a manner that the vehicle drives as close as possible to the city limits or the region with a speed limit and then decelerates accordingly in order to reach the predefined speed.

Another embodiment of the invention provides a method for automatically controlling the speed of a vehicle. According to this method, a position signal with the current position of the vehicle is emitted. As a function of the position signal, the distance of the vehicle from the nearest city limits or a region with a speed limit in the direction of travel of the vehicle is determined by means of the data of a navigation database. Then, as a function of the determined distance, a speed setting signal is generated that decreases the current speed of the vehicle in such a manner that a predefined speed of the vehicle is reached no later than at the nearest city limits or the region with a speed limit.

Furthermore, the allowable speeds in localities may be stored in the navigation database. Moreover, in order to determine the nearest city limits in the direction of travel, an allowable speed in the respective locality may be used as the predefined speed. Also, the altitude profiles of roads may be stored in the navigation database. The altitude profile of the road, on which the vehicle is driving momentarily, may be considered in decreasing the current speed of the vehicle.

As a function of the determined distance, an optimal location, at which the decrease in the current speed of the vehicle is started, may also be determined. For example, the optimal location may be determined in terms of optimizing the time required to reach the city limits or the region. As an alternative, the optimal location may also be determined in terms of optimizing the energy required to reach the city limits or the region.

Furthermore, another embodiment provides a computer program for implementing the method of the invention, which computer program is executable on a computer. Also, one embodiment of the invention provides a data carrier, on which is stored the computer program of the invention.

The description, the claims, the abstract and the drawing include the terms and respective reference numerals that are cited in the attached list of reference numerals.

### BRIEF DESCRIPTION OF THE DRAWINGS

The single drawing is a block diagram of one embodiment of the device for automatically controlling the speed of a vehicle in accordance with the invention.

### DETAILED DESCRIPTION OF THE INVENTION

The illustrated device 10 comprises, as a central unit, a speed control unit 18, which can emit a control setting signal 20 to a control device in the vehicle. This control device is responsible for controlling the speed of the vehicle—for example, an engine control unit with an electronic torque control, an electronic transmission control or an electronic brake control unit. The speed setting signal 20, generated by the speed control unit 18, can be fed especially into a vehicle bus system, to which is attached the control device, which is to be controlled and which is intended for influencing the speed of the vehicle.

In order to generate the speed setting signal 20, the speed control unit 18 receives a plurality of different input signals and information, which said speed control unit processes, in particular, with a computational algorithm for optimum speed control, in order to produce the speed control signal 20. To this end, the speed control unit 18 comprises as a computer, which is configured to process the signals and the information that are fed in (described in detail below).

Furthermore, additional essential components of the device 10 include:
A positioning sensor 12—for example, a satellite locating system, such as a GPS (global positioning system) or the future European satellite navigation system, which continuously generates a position signal 14 that is fed to the speed control unit 18, and signals the current position of the vehicle.
A speed setting device 22 for manually setting a desired speed generates a target speed signal 24, which serves to set (in as constant a manner as possible) the desired vehicle speed, set by the driver of the vehicle.

Furthermore, a navigation database 16 is also connected to the speed control unit 18. The positions of the city limits and other regions with speed limits are stored in said navigation database. The navigation database 16 may be, in particular, the database of a conventional, commercially available navigation system, as currently offered by a number of manufacturers.

During normal operations the driver of the vehicle usually sets by hand a desired speed by means of the speed setting device 22—for example, the maximum allowable speed, when driving on a highway between two localities. Then this desired speed is passed on, as the target speed signal 24, to the speed control unit 18, which then sets the speed setting signal 20 in such a manner that the desired speed is reached by the vehicle.

The speed control unit 18 receives continuously from the positioning sensor 12 the position signal 14, which indicates the current position of the vehicle. On the basis of the current vehicle position, which is transmitted with the position signal 14, the speed control unit 18 fetches from the navigation database 16 the navigation data with regard to the position of the vehicle. These navigation data comprise chiefly the positions of city limits and other regions with a speed limit. At this stage the speed control unit 18 determines the distance of the current vehicle position from the nearest region with a speed limit in the direction of travel—thus, for example, the distance between the nearest city limits and the place, which presumably the vehicle will reach as the next destination. Using the distance, which is calculated in this manner, and the current speed of the vehicle, the speed control unit 18 calculates how the speed of the vehicle ought to be adjusted during the trip to the city limits.

To this end two inputs may be defined in advance: energy or time optimal speed control. In both cases the location is calculated, at which the speed must be automatically decreased in order to drive at the allowable local speed on reaching the city limits. In other words, starting at a defined calculated position of the vehicle, the speed of the vehicle is automatically decreased until the allowable local speed is reached as precisely as possible at the city limits. The automatic speed reduction operation may include other parameters, such as the altitude profile of the road. These parameters may also be fetched from the navigation database 16, insofar as they are stored in said database.

In particular, the invention makes it possible during a speed control—“cruise control”—to avoid having to decelerate the vehicle on reaching a region with a speed limit, a maneuver that is disadvantageous in terms of energy. Rather the invention makes it possible to automatically control in a fuel saving manner the speed of a vehicle as a function of the allowable speeds in specific regions, like localities or the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

10 device for automatically controlling the speed of a vehicle
12 positioning sensor
14 position signal
16 navigation database
18 speed control unit
20 speed setting signal
22 speed setting device
24 target speed signal

What is claimed is:

1. Apparatus for automatically controlling the speed of a vehicle, said apparatus comprising:
a positioning sensor, which emits a position signal indicative of current position of the vehicle;
a navigation database, in which the positions of city limits are stored; and
a speed control unit, to which the position signal is fed and which is configured to determine, as a function of the position signal, a distance of the vehicle from the nearest city limits or a region with a speed limit in the direction of travel of the vehicle, based on the data of the navigation database, to generate , as a function of the determined distance, a speed setting signal, which reduces the current speed of the vehicle in such a manner that a predefined speed of the vehicle is reached no later than at the nearest city limits or the nearest region with a speed limit.

2. The apparatus as claimed in claim 1, wherein:
allowable local speeds are stored in the navigation database; and
the speed control unit is configured to use an allowable local speed in an approaching locality as the predefined speed in order to determine the nearest city limits in the direction of travel.

3. The apparatus as claimed in claim 1, wherein:
elevation profiles of roads are stored in the navigation database; and
the speed control unit is configured to consider the altitude-profile of the road, on which the vehicle is currently driving, in the generation of the speed setting signal.

4. The apparatus as claimed in claim 1, wherein:
a digital terrain model is filed in a-second navigation database;
the navigation databases are used to determine the altitude profile of roads;
the speed control unit is configured to consider the elevation profile of the road on which the vehicle is currently driving, in generating the speed setting signal.

5. The apparatus as claimed in claim 1, wherein the speed control unit is configured to determine, as a function of the determined distance, an optimal location at which to initiate the decrease in the current speed of the vehicle.

6. The apparatus as claimed in claim 5, wherein the speed control unit is configured to determine said optimal location to optimize the time required to reach the city limits or the region.

7. The apparatus as claimed in claim 5, wherein the speed control unit is configured to determine said optimal location to optimize the energy required to reach the city limits or the region.

8. A method for automatically controlling the speed of a vehicle, said method comprising:
emitting a position signal indicative of current position of the vehicle
as a function of the position signal determining distance of the vehicle from the nearest city limits or a region with a speed limit in the direction of travel of the vehicle, based on data of a navigation database; and
as a function of the determined distance, generating a speed setting signal that decreases current speed of the vehicle such that a predefined speed of the vehicle is reached no later than when the vehicle reaches the nearest city limits or a nearest region with a speed limit.

9. The method as claimed in claim 8, wherein:
allowable speeds in localities are stored in the navigation database; and
in order to determine the nearest city limits in the direction of travel, an allowable speed in an approaching locality is used as the predefined speed.

10. The method as claimed in claim 8, wherein:
an elevation profile of roads is stored in the navigation database; and
the elevation profile of the road on which the vehicle is traveling is considered in decreasing the current speed of the vehicle.

11. The method as claimed in claim 8, wherein as a function of the determined distance, an optimal location, at which the decrease in the current speed of the vehicle is started, is determined.

12. The method as claimed in claim 11, wherein the optimal location is determined to optimize the time required to reach the city limits or the region.

13. The method as claimed in claim 11, wherein the optimal location is determined to optimize the energy required to reach the city limits or the region.

14. A computer program product comprising a computer readable medium encoded with a program for causing a data processor in a vehicle to perform the following tasks:
emitting a position signal indicative of current position of the vehicle;
as a function of the position signal determining distance of the vehicle from the nearest city limits or a region with a speed limit in the direction of travel of the vehicle, based on data of a navigation database; and
as a function of the determined distance, generating a speed setting signal that decreases current speed of the vehicle such that a predefined speed of the vehicle is reached no later than when the vehicle reaches the nearest city limits or a nearest region with a speed limit.
